(19) United States
(12) Patent Application Publication
(10) Pub. No.: US 2020/0125909 A1
(43) Pub. Date: Apr. 23, 2020

(54) SOFT RFID CARELABEL WITH PRINTED ANTENNA

(71) Applicant: r-pac International Corp., New York City, NY (US)

(72) Inventor: Michael Teitelbaum, New York City, NY (US)

(73) Assignee: r-pac International Corp., New York City, NY (US)

(21) Appl. No.: 16/365,406

(22) Filed: Mar. 26, 2019

Related U.S. Application Data
(60) Provisional application No. 62/746,684, filed on Oct. 17, 2018.

(51) Int. Cl. G06K 19/077

(52) U.S. Cl. CPC G06K 19/0776; G06K 19/07707; G06K 19/07777; G06K 19/07762

(57) ABSTRACT

Technologies are generally provided for soft carelabels with integrated RFID tags. A fabric or similar flexible material may be used as substrate for the label and either pre- or post-printed with textual and/or graphical information for an item. The entire substrate surface or a portion under the RFID antenna may be coated with protective coating. The RFID antenna may then be printed on the protective coating using conductive ink through screen printing or similar techniques. The antenna may have one or more segments and two or more contacts for an RFID IC. Upon curing the conductive ink, the RFID IC may be attached to the antenna for galvanic, capacitive, or inductive coupling between the RFID circuits and the RFID antenna. The soft carelabel with the RFID tag may be further processed and/or treated and the RFID IC may be partially or completely programmed before being attached to the item.

### CROSS REFERENCE TO RELATED APPLICATIONS

This application claims the benefit of U.S. Provisional Patent Application Ser. No. 62/746,684 filed on Oct. 17, 2018. The disclosures of the provisional patent application are hereby incorporated by reference in their entirety.

### BACKGROUND

Unless otherwise indicated herein, the materials described in this section are not prior art to the claims in this application and are not admitted to be prior art by inclusion in this section.

Radio frequency identification (RFID) tags are increasingly replacing other forms of identification technology such as barcodes due to their advanced features such as amount of data that can be stored, accessibility of the data without line-of-sight access to the label, security, re-programming, and many others. RFID tags typically include an RFID IC with a processor, memory, and some ancillary circuits, an antenna, and a substrate. While RFID tags can be made in very small dimensions, conventional RFID tags include a hard antenna (and typically a hard substrate). In some industries, such as the garment industry, soft labels are preferred, if not required. Thus, integrating or replacing current soft labels (carelabels) with the advanced technology of RFID tags presents challenges.

### SUMMARY

The present disclosure generally describes techniques for integrating RFID tags with soft labels for consumer or other items. Specifically, integration techniques are described for RFID tags into soft carelabels, which include information about apparel items such as garments, where the techniques provide for survival of the RFID tags through the wear and tear of a supply chain, as well as, consumer use.

Embodiments described herein illustrates methods, devices, and systems to overcome challenges of conventional technologies in integrating RFID tags with soft labels for consumer or other items. In some examples, a soft substrate that serves as the carelabel may be coated with a protective coating label such as ultraviolet coating. RFID tag antenna may be created over the protective coating by deposition of conductive ink, where the protective coating prevents the conductive ink from penetrating the substrate, thus, allowing the ink to stay on the surface and enhance a reliability of the carelabel. An RFID IC may then be integrated with the antenna through a number of approaches providing an activated tag. Further optional process steps may include additional protective coating, programming of the RFID tag, and similar ones.

The foregoing summary is illustrative only and is not intended to be in any way limiting. In addition to the illustrative aspects, embodiments, and features described above, further aspects, embodiments, and features will become apparent by reference to the drawings and the following detailed description. Thus, the foregoing summary is not exhaustive or limiting but rather example of different embodiments non-obvious and unique to a person skilled in the art.

### BRIEF DESCRIPTION OF THE DRAWINGS

The foregoing and other features of this disclosure will become more fully apparent from the following description and appended claims, taken in conjunction with the accompanying drawings. Understanding that these drawings depict only exemplary embodiments in accordance with the disclosure and are, therefore, not to be considered limiting of its scope, the disclosure will be described with additional specificity and detail through use of the accompanying drawings, in which:

FIG. 1 includes an illustration of a soft carelabel with an RFID tag;

FIG. 2 includes a conceptual illustration of the layers of an example soft carelabel with an RFID tag;

FIG. 3A includes a conceptual illustration of an example system to manufacture soft carelabels with RFID tags;

FIG. 3B includes a conceptual illustration of example soft carelabels with RFID tags prior to being cut;

FIG. 4 includes a flowchart of example actions in providing soft carelabels with RFID tags;

FIG. 5 illustrates major components of an example system for providing soft carelabels with RFID tags;

FIG. 6 illustrates a computing device, which may be used to manage a system to manufacture soft carelabels with RFID tags; and

FIG. 7 illustrates a block diagram of an example computer program product, all of which are arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein. Additionally, the sequence of flow of the example embodiments may be changed depending on context of user scenario of specific embodiments.

This disclosure is generally drawn, inter alia, to methods, apparatus, systems, devices, and/or computer program products related to RFID tags integrated with soft labels for consumer or other items and manufacture of such soft carelabels.

Briefly stated, technologies are generally described for soft carelabels with integrated RFID tags. A fabric based on similar flexible material may be used as substrate for the label and either pre- or post-printed with textual and/or graphical information for an item such as source, care instructions, regulatory information, etc. The entire substrate surface or just the area under the RFID antenna may be coated with protective coating, for example, UV protective varnish. The RFID antenna may then be printed on the protective coating using conductive ink through screen printing or similar techniques. The antenna may have one or more segments and two or more contacts for an RFID IC. Upon curing the conductive ink, the RFID IC may be attached to the antenna for galvanic, capacitive, or inductive coupling between the RFID circuits and the RFID antenna. The soft carelabel with the RFID tag may be further processed and/or treated and the RFID IC may be partially or completely programmed before being attached to the item.

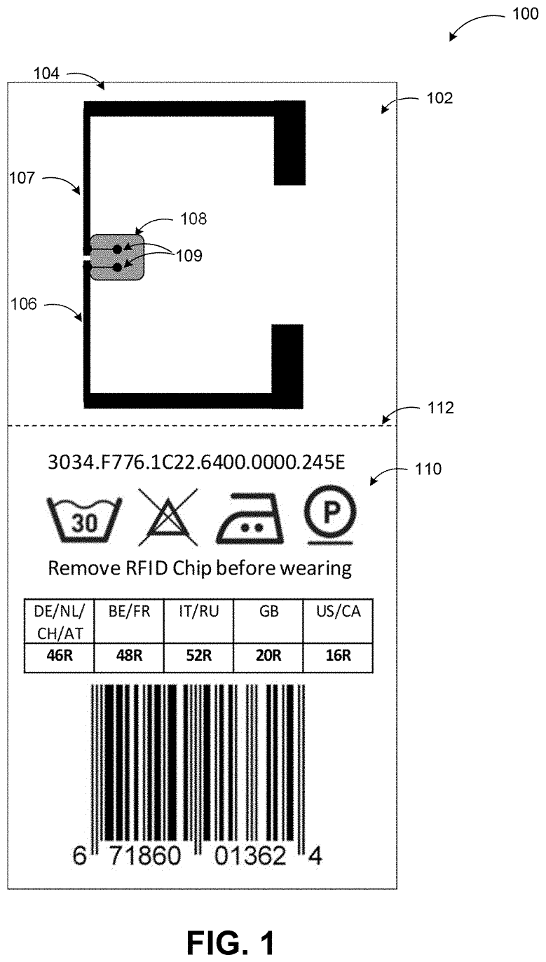

FIG. 1 includes an illustration of a soft carelabel with an RFID tag, arranged in accordance with at least some embodiments described herein.

As shown in FIG. 1, a soft carelabel 100 may include a substrate 102, an RFID tag 104, and instructions 110. The substrate 102 may include any material suitable for printing on, flexible, and resistant to wear and tear. Non-exhaustive examples of the substrate 102 may include satin, nylon, polyester, cotton, silk, and comparable materials such as natural or synthetic fibers or recycled material such as a recycled polyester or PET. In some examples, substrate 102 may be coated or treated to better withstand washing conditions or may be treated with other materials such as flame-retardant chemicals. Soft carelabel 100 is typically associated with (and attached to) an item. Thus, instructions 110 may be printed on or otherwise deposited on the soft carelabel 100. Instructions 110 may include information associated with the item, care instructions, and other information. Instructions 110 may include text, graphics, or any combination thereof. RFID tag 104 may typically include an antenna and an RFID IC 108. The antenna may include a one-piece radiating element (e.g., monopole) or two radiating elements 106, 107 (e.g., dipole).

In typical RFID systems, an RFID reader transmits a modulated RF inventory signal (a command), receives a tag reply, and transmits an RF acknowledgement signal responsive to the tag reply. A tag that senses the interrogating RF wave may respond by transmitting back another RF wave. The tag either generates the transmitted back RF wave originally, or by reflecting back a portion of the interrogating RF wave in a process known as backscatter. Backscatter may take place in a number of ways. The reflected-back RF wave may encode data stored in the tag, such as a number. The response is demodulated and decoded by the reader, which thereby identifies, counts, or otherwise interacts with the associated item. The decoded data can denote a serial number, a price, a date, a time, a destination, an encrypted message, an electronic signature, other attribute(s), any combination of attributes, and so on. Accordingly, when a reader receives tag data it can learn about the item that hosts the tag and/or about the tag itself.

The RFID IC 108 may include a transceiver section, a power-management section, and frequently a logical section, a memory, or both. The memory may include ROM, RAM, SRAM, DRAM, NVM, EEPROM, FLASH, Fuse, MRAM, FRAM, and other similar volatile and nonvolatile information-storage technologies as will be known to those skilled in the art. In some RFID tags the power-management section may include an energy storage device such as a battery. RFID tags with an energy storage device are known as battery-assisted, semi-active, or active tags. Other RFID tags can be powered solely by the RF signal they receive. Such RFID tags do not include an energy storage device and are called passive tags. Passive tags may typically include temporary energy- and data/flag-storage elements such as capacitors or inductors.

The RFID tag 104 may communicate with an RFID reader via signals. When communicating, each may encode, modulate, and transmit data to the other, and receive, demodulate, and decode data from the other. The data may be modulated onto, and demodulated from, RF waveforms. The RF waveforms are typically in a suitable range of frequencies, such as those near 900 MHz, 13.56 MHz, and so on. The RFID tag may use the antenna (106, 107) for exchanging wireless signals with its environment. The antenna (106, 107) may often be flat and attached to the substrate 102. The RFID IC 108 may be electrically coupled to the antenna 106 via suitable contacts 109. The term “electrically coupled” as used herein may mean a direct electrical connection, or it may mean a connection that includes one or more intervening circuit blocks, elements, or devices. The “electrical” part of the term “electrically coupled” as used in this document shall mean a coupling that is one or more of ohmic/galvanic, capacitive, and/or inductive. Similarly, the terms “electrically isolated” or “electrically decoupled” as used herein mean that electrical coupling of one or more types (e.g., galvanic, capacitive, and/or inductive) is not present, at least to the extent possible. For example, elements that are electrically isolated from each other are galvanically isolated from each other, capacitively isolated from each other, and/or inductively isolated from each other. Of course, electrically isolated components will generally have some unavoidable stray capacitive or inductive coupling between them, but the intent of the isolation is to minimize this stray coupling to a negligible level when compared with an electrically coupled path.

In a typical operation, the antenna (106, 107) may receive a signal and communicate it to the RFID IC 108, which may both harvest power and respond if appropriate, based on the incoming signal and the IC's internal state. If the RFID IC 108 uses backscatter modulation, then it may respond by modulating the antenna's reflectance. As mentioned above, an RFID tag such as RFID tag 104 is often attached to or associated with an individual item or the item packaging. An RFID tag may be fabricated and then attached to the item or packaging or may be partly fabricated before attachment to the item or packaging and then completely fabricated upon attachment to the item or associated label(s). In some embodiments, the RFID tag may be integrated into the item, labels, or packaging, and portions of the item, labels, or packaging may serve as tag components. For example, conductive portions may serve as tag antenna segments or contacts. Nonconductive item, label, or packaging portions may serve as tag substrates or inlays. In the example of FIG. 1, the material of the soft carelabel 100 (substrate 102) may serve both as the printing base for the instructions 110 and the substrate for the RFID antenna (106, 107).

In garment care and other apparel related labels, typically include care instructions, brand identification and other information such as source origin that are either required by certain regulations or are used in connection with the manufacturers marketing objectives. Such garments or other labels can be irritating to the skin due to the presence of stiff backers provided in the label. This can be particularly problematic where portions of the tag are removed leaving a stub or alternatively where a consumer attempts to remove the entire tag and potentially damages the garment. The RFID tag 104 may include the option to preserve privacy by being able to selectively remove the tag from the garment or other consumer good. Removal of the tag may not create an irritating condition for the wearer of the garment.

In some examples, the flexible substrate may have a second dimension at least one and half times greater than a first dimension, where the RFID antenna may be printed on the flexible substrate 102 using conductive ink. A protective coating layer deposited between the substrate and the conductive ink may allow the ink to stay on the surface (as opposed to penetrating the substrate) and provide for longevity through the supply chain operations and consumer use.

While example embodiments are shown as a distinct garment label herein, a soft carelabel with an RFID tag may also be integrated into the garment itself. Thus, the substrate 102 may be the fabric of the garment of an integrated portion thereof. In further examples, the RFID tag portion of the soft carelabel 100 may be removable through cutting or tearing at any point in the supply chain or post-consumer sale. For example, a cut or a tear line 112 may be provided on the soft carelabel 100. In this manner, the tag portion may be cut away such as with scissors or knife or alternatively may be torn if the tag is perforated such as with microperforations or larger cuts and ties.

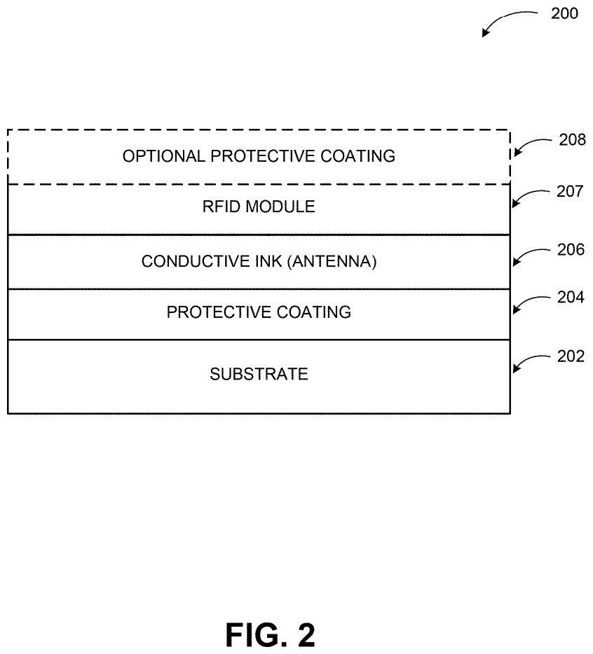

FIG. 2 includes a conceptual illustration of the layers of an example soft carelabel with an RFID tag, arranged in accordance with at least some embodiments described herein.

As shown in diagram 200, substrate 202 may be the core material of a soft carelabel or a garment itself. As such, the substrate 202 may include satin, nylon, polyester, cotton, silk, and comparable materials such as natural or synthetic fibers or recycled material such as a recycled polyester or PET. Protective coating 204 may be applied to a surface of the substrate 202 to allow the conductive ink forming the antenna to stay on the surface and not penetrate the substrate 202. For example, a 7μ thick layer of a UV varnish may be applied as the protective layer 204 and dried. In some examples, a print layout of the protective layer 204 (e.g., varnish) may similar or identical to the antenna layout that is printed on top of the protective layer. By preventing seepage of the conductive ink into the substrate, which is typically a fabric material, an integrity of the conductive ink layer may be preserved allowing the RFID antenna to have predictable and reliable RF characteristics, as well as, survive the wear and tear of the supply chain and consumer use (e.g., wash and dry cycles, etc.) The protective layer 204 may be applied by using screen printing or similar methods. A protective layer may not be necessary when using coated fabrics like Nylon taffeta or Polyester as substrate.

The conductive ink layer 206 forms the RFID antenna, which may include one or more segments. In a typical embodiment, the antenna may be formed using two segments and the RFID IC may be inserted between the two segments activating the RFID tag (providing electrical connection between the RFID IC circuitry and the antenna). Depending on the RFID tag and intended use, the antenna may be a monopole, dipole, or other forms of RF antenna suitable for the communication frequency of the RFID tag.

An RFID module 207 (RFID IC and any intermediary connections) may be applied to the printed antenna with RFID IC terminals making galvanic, capacitive, or inductive connections with antenna terminals. In some examples, an additional and optional protective coating layer 208 may be applied over the conductive ink layer 206 and RFID module 207 to better withstand washing and wear conditions, for example. Furthermore, the soft carelabel may be treated with other materials such as flame-retardant chemicals.

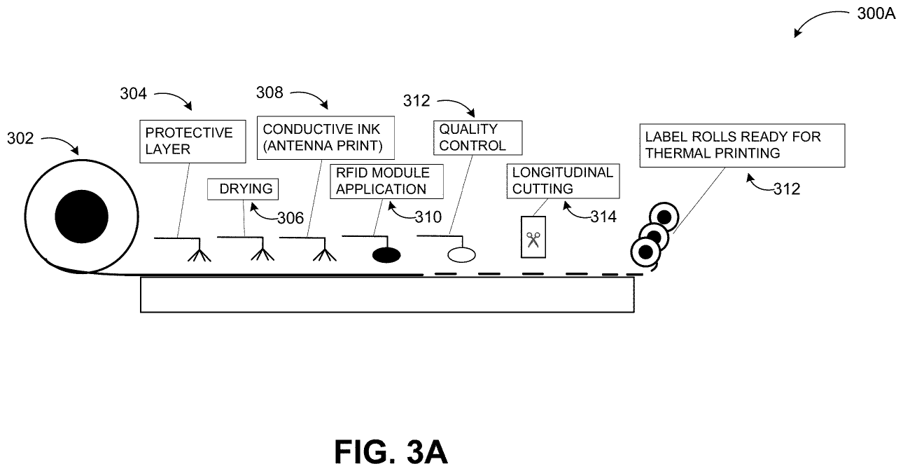

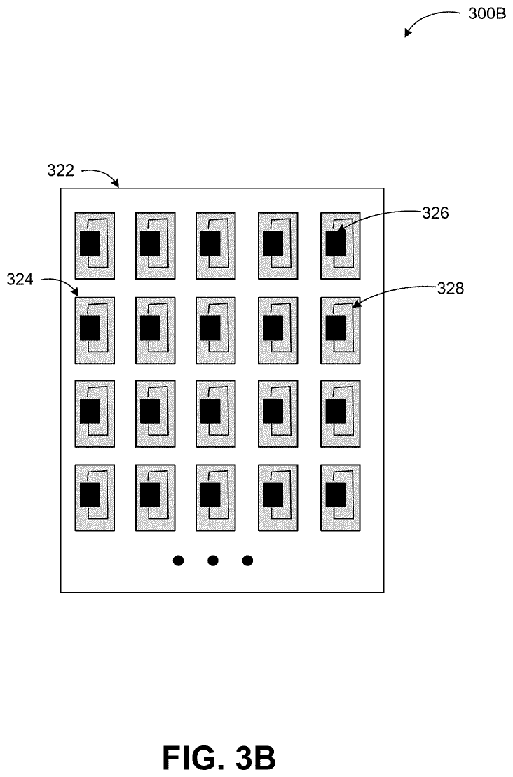

FIG. 3A includes a conceptual illustration of an example system to manufacture soft carelabels with RFID tags, arranged in accordance with at least some embodiments described herein.

The example manufacturing system shown in diagram 300A may provide the substrate for the soft carelabels in form of a roll 302 (of fabric, for example). A protective layer application module 304 may spray on or comparably deposit a protective coating such as varnish onto the substrate. The applied protective coating may be dried at a drying module 306 before the RFID antenna is printed onto the label (over the protective coating) with conductive ink at conductive ink application module 308. Screen printing or comparable techniques may be used to apply the conductive ink. The conductive ink layer may also be dried. RFID modules may be applied 310 to the labels. A quality control process 312 may be performed on the labels with RFID modules to check for structural and/or functional performance. Subsequently, the carelabels with RFID modules may be cut longitudinally at cutting module 314. The resulting rolls of labels 316 may be provided to other manufacturing stations or customers for thermal printing (textual and/or graphic information such as source, care instructions, etc.), singulation, and integration with items such as garments, where the labels may be glued, sewn, or otherwise attached to the items.

As mentioned herein, the antenna may be any form of antenna suitable for RFID tag use. Conductive ink used to form the antenna may also be selected among a number of commercially or otherwise available inks. One example conductive ink may be Loctite EDAG PM406V1 by HENKEL NEDERLAND BV, which is a thermoplastic material with silver filling and cured through hot air drying at selected temperatures and time periods depending on application type. Using the example conductive ink, the RFID antenna may be printed in 14 micrometer thickness of the UV protective coating.

In another example implementation, PU coated slit edge Satin material (width 280 mm) may be used. The selected width may guarantee a constant web tension when the material is running through the manufacturing machine. Especially the process step of applying the loop onto the antenna may require high precision. Therefore, constant web tension may be desired. 3 mm black reflexbar (Flexo) may be applied for downstream processes. Reflexbar may also be printed later in the process as well. 7μ UV varnish may be applied onto the Satin substrate by screen printing and UV drying. 14μ conductive ink may be applied onto the varnish area by screen printing and drying via 4 hot air units. The syst3em may ensure that the conductive ink layer is fully dry before applying antenna loops or re-winding the material. Loops may be applied precisely with an applicator (e.g., 7 across). Longitudinal cut of the material to final width and conversion may be performed for further processing. Cutting may be accomplished with stump knifes or ultrasonically. An example processing speed for the manufacturing machine may be 6-7 m (of substrate) per minute.

FIG. 3B includes a conceptual illustration of example soft carelabels with RFID tags prior to being cut, arranged in accordance with at least some embodiments described herein.

As shown in diagram 300B, soft carelabels 324 may be laid out in a matrix formation on a roll of substrate 322 in some examples. More suitable for mass manufacturing, such configurations may allow multiple labels to be produced in relatively short time. Each label may include an RFID IC 326 and an RFID antenna 328 as discussed herein. In other examples, the labels may be manufactured individually, in row of one label each, or in other configurations suitable to the manufacturing process, label type, and numbers of labels to be produced.

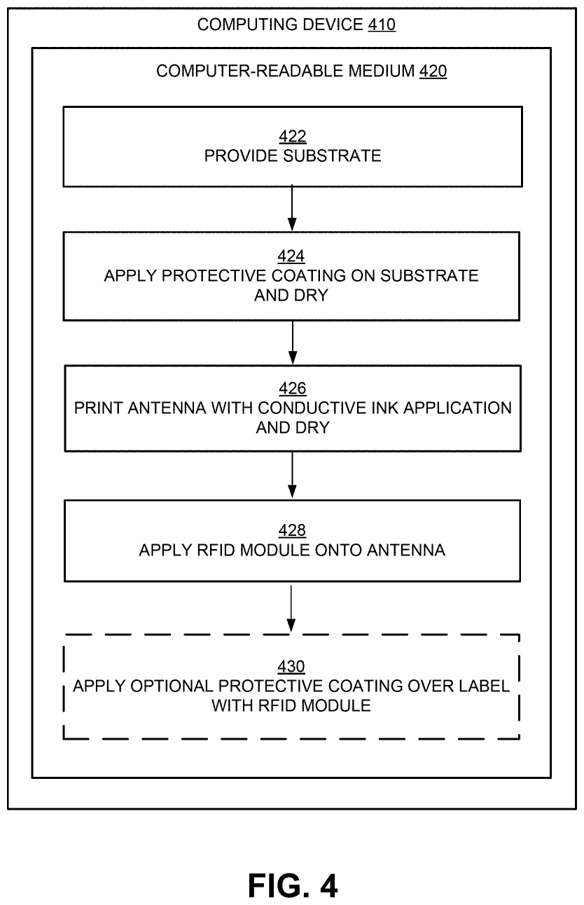

FIG. 4 includes a flowchart of example actions in providing soft carelabels with RFID tags, arranged in accordance with at least some embodiments described herein.

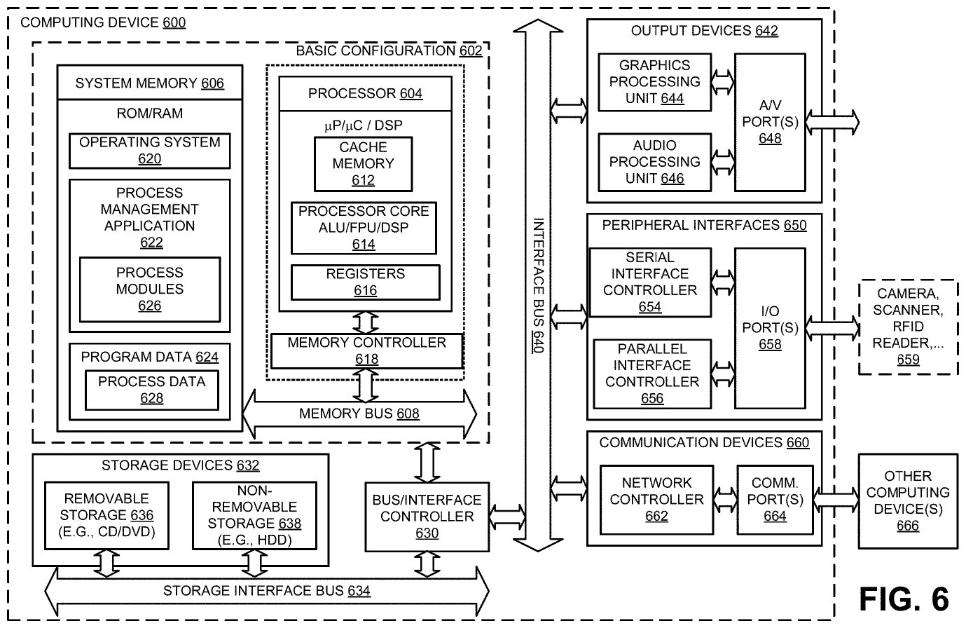

Example methods may include one or more operations, functions, or actions as illustrated by one or more of blocks 422, 424, 426, 428, and 430 may in some embodiments be performed by a computing device such as the computing device 600 in FIG. 6. Such operations, functions, or actions in FIG. 6 and in the other figures, in some embodiments, may be combined, eliminated, modified, and/or supplemented with other operations, functions or actions, and need not necessarily be performed in the exact sequence as shown. The operations described in the blocks 422-430 may be implemented through execution of computer-executable instructions stored in a computer-readable medium such as a computer-readable medium 420 of a computing device 410.

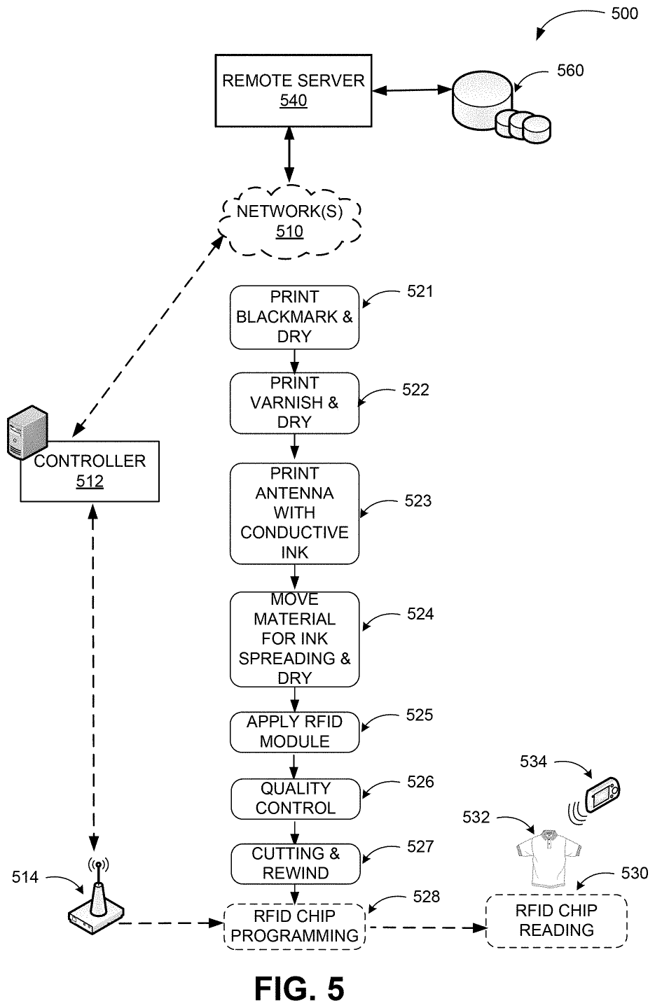

An example process to provide RFID tags printed on soft carelabels begin with block 422, “PROVIDE SUBSTRATE”, where a system such as the system described in FIG. 5 may provide the substrate material for the carelabel such as the example fabric-based or other type materials discussed herein.

Block 422 may be followed by block 424, “APPLY PROTECTIVE COATING ON SUBSTRATE AND DRY”, where UV protective material such as varnish may be applied onto the substrate and dried by application of air, UV lighting, or other means. The protective coating may cover the entire surface of the substrate or may have a footprint similar or identical to the antenna to be printed using conductive ink in the subsequent step.

Block 424 may be followed by block 426, “PRINT ANTENNA WITH CONDUCTIVE INK APPLICATION AND DRY”, where the RFID antenna may be printed onto the protective coating using conductive ink through directed spraying, controlled droplet application, screen printing, and similar mechanisms. The printed antenna may also be dried using suitable methods.

Block 426 may be followed by block 428, “APPLY RFID MODULE ONTO ANTENNA”, where the RFID IC may be placed onto the carelabel to have electrical connection with the antenna contacts. The RFID IC and the antenna may be coupled through galvanic coupling (direct electrical contact by pressing, soldering, or other means between the IC contacts and antenna contacts), capacitive (e.g., through a dielectric layer), or inductive coupling (coupling between the IC contacts and the antenna contact via a dielectric layer such as an oxide layer on IC surface or the optional protective layer discussed above).

Block 428 may be followed by optional block 430, “APPLY OPTIONAL PROTECTIVE COATING OVER LABEL WITH RFID MODULE”, where an additional layer of protective coating material may be applied over the label also covering the RFID module to prevent wear and tear or for other purposes.

The operations included in process 400 are for illustration purposes. Soft carelabels with RFID tags may be implemented by similar processes with fewer or additional operations, as well as in different order of operations using the principles described herein. The operations described herein may be executed by one or more processors operated on one or more computing devices, one or more processor cores, and/or specialized processing devices, among other examples.

FIG. 5 illustrates major components of an example system for providing soft carelabels with RFID tags, arranged in accordance with at least some embodiments described herein.

The example system shown in diagram 500 may include a remote server 540 managing operations of a manufacturing system according to embodiments, one or more data stores 560 storing soft carelabel data, process data, and similar information. The remote server 540 may communicate with one or more controllers managing the manufacturing system's individual modules such as controller 512 over one or more networks, which may include private, public, wired, wireless, and other forms of networks using any suitable protocols (e.g., terrestrial and/or satellite-based communications or a combination thereof).

The manufacturing system may include individual process modules for following process steps: Printing blackmark and drying 521, where flexography may be used. Flexography is a form of printing process which utilizes a flexible relief plate, which can be used for printing on any type of substrate, including plastic, fabric, metallic films, cellophane, and paper. Flexography is widely used for printing on the non-porous substrates and is also well suited for printing large areas of solid color. Next, UV varnish (protective coating) may be printed to prevent conductive ink from seeping into the substrate material (522) and dried. The antenna may be printed (523) with conductive ink over the UV varnish. Then, the material (substrate with UV varnish and conductive ink) may be moved (524), for example, 90 degrees up in the air (up to about 2 m) to give time to the conductive ink to spread and build an optimally filled surface. The conductive ink may be dried using hot-air drying systems. The RFID module including the RFID IC may be applied (525) onto the antenna, where surface contacts on the RFID IC or RFID module connecting to the antenna may make the RFID tag operational. At quality control step 526, fitting of UV varnish and antenna on the surface of the substrate, functionality of the RFID module, etc. may be checked using a camera, an RFID reader, or similar methods. The substrate material (usually including multiple rows and columns of carelabels) may be cut (527) longitudinally and rewound into rolls ready for thermal printing, singulation, and integration with items.

In some implementations, a second production process may include cutting out bad parts and rewinding correctly for thermal printing and another quality control step without marking. Input devices such as cameras, scanners, RFID readers may be used for enhanced quality control results. The RFID tag(s) may also be programmed at this step (528) or later when integrated with an item. These process steps and modules are illustrative examples, and a manufacturing system according to embodiments may include more or fewer modules and process steps. Each process step may be performed at individually dedicated stations or combined in groups.

In yet other examples, the RFID ICs may be partially or completely programmed upon completion of the manufacturing process. The programming may be through wired means or through an RFID reader 514, which may be controller by controller 512. For example, manufacturer information may be encoded into the RFID ICs at the end of the manufacturing process. Other information such as individual item identifiers, date and lot information, etc. may be encoded into the RFID tag subsequently. The soft carelabels may be attached to garments 532 (or integrated). At a later time, the RFID tag information may be read 530 from the RFID ICs by another RFID reader 534.

FIG. 6 illustrates a computing device, which may be used to manage a system to manufacture soft carelabels with RFID tags, arranged in accordance with at least some embodiments described herein.

In an example basic configuration 602, the computing device 600 may include one or more processors 604 and a system memory 606. A memory bus 608 may be used to communicate between the processor 604 and the system memory 606. The basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one or more levels of caching, such as a cache memory 612, a processor core 614, and registers 616. The example processor core 614 may include an arithmetic logic unit (ALU), a floating point unit (FPU), a digital signal processing core (DSP core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. The system memory 606 may include an operating system 620, a process management application 622, and program data 624. The process management application 622 may include one or more process modules 626. The process management application 622 may be configured to manage the manufacturing process of a soft carelabel with integrated RFID tag through one or more process modules 626, where each module may control the operations of a manufacturing module such as application of protective layer, drying of protective layer, application of conductive ink, etc. The program data 624 may include process data 628 such as material types, thicknesses to be applied, etc., as described herein.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDDs), optical disk drives such as compact disc (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives (SSDs), or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (e.g., one or more output devices 642, one or more peripheral interfaces 650, and one or more communication devices 660) to the basic configuration 602 via the bus/interface controller 630. Some of the example output devices 642 include a graphics processing unit 644 and an audio processing unit 646, which may be configured to communicate to various external devices such as a display or speakers via one or more A/V ports 648. One or more example peripheral interfaces 650 may include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. In some examples, a camera, a scanner, an RFID reader, or similar devices 659 may be used for quality control processes checking structural and functional aspects of the labels and connecting to the computing device through the I/O ports 658. An example communication device 660 includes a network controller 662, which may be arranged to facilitate communications with one or more other computing devices 666 over a network communication link via one or more communication ports 664. The one or more other computing devices 666 may include servers at a datacenter, customer equipment, and comparable devices.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include non-transitory storage media.

The computing device 600 may be implemented as a part of a specialized server, mainframe, or similar computer that includes any of the above functions. The computing device 600 may also be implemented as a personal computer including both laptop computer and non-laptop computer configurations.

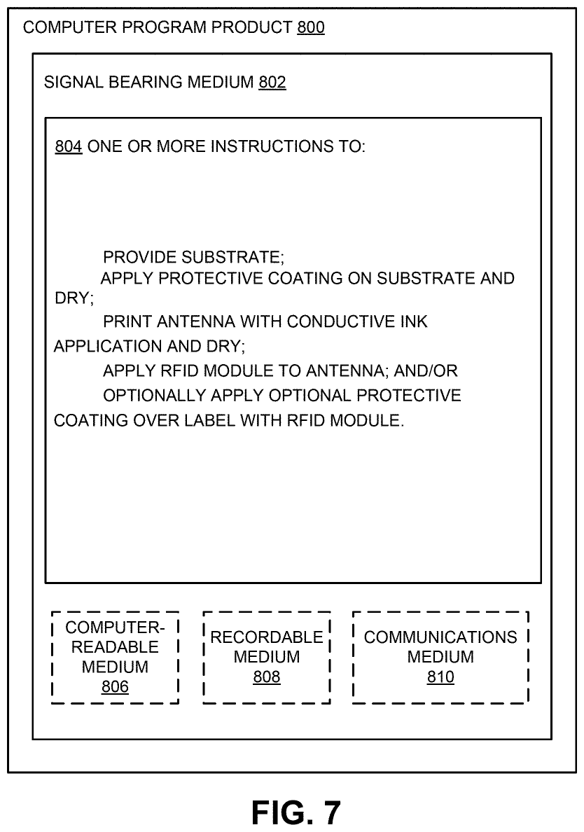

FIG. 7 illustrates a block diagram of an example computer program product, arranged in accordance with at least some embodiments described herein.

In some examples, as shown in FIG. 7, a computer program product 700 may include a signal bearing medium 702 that may also include one or more machine readable instructions 704 that, in response to execution by, for example, a processor may provide the functionality described herein. Thus, for example, referring to the processor 604 in FIG. 6, the process management application 622 may perform or control performance of one or more of the tasks shown in FIG. 7 in response to the instructions 704 conveyed to the processor 604 by the signal bearing medium 702 to perform actions associated with the manufacture of soft carelabels with RFID tags as described herein. Some of those instructions may include, for example, provide substrate, apply protective coating on substrate and dry, print antenna with conductive ink and dry, apply RFID module onto antenna, and/or optionally apply optional protective coating over label with RFID module, according to some embodiments described herein.

In some implementations, the signal bearing medium 702 depicted in FIG. 7 may encompass computer-readable medium 706, such as, but not limited to, a hard disk drive (HDD), a solid state drive (SSD), a compact disc (CD), a digital versatile disk (DVD), a digital tape, memory, etc. In some implementations, the signal bearing medium 702 may encompass recordable medium 707, such as, but not limited to, memory, read/write (R/W) CDs, R/W DVDs, etc. In some implementations, the signal bearing medium 702 may encompass communications medium 710, such as, but not limited to, a digital and/or an analog communication medium (e.g., a fiber optic cable, a waveguide, a wired communication link, a wireless communication link, etc.). Thus, for example, the computer program product 700 may be conveyed to one or more modules of the processor 604 by an RF signal bearing medium, where the signal bearing medium 702 is conveyed by the communications medium 710 (e.g., a wireless communications medium conforming with the IEEE 802.11 standard).

According some examples, a garment carelabel integrated with a radio frequency identification (RFID) tag is described. The carelabel may include a flexible substrate; a layer of first protective coating applied on a surface of the substrate; an RFID tag antenna printed with conductive ink onto a portion of the surface of the substrate covered with the layer of the first protective coating; and an RFID integrated circuit (IC) electrically coupled to the RFID tag antenna.

According to other examples, the garment carelabel may further include a layer of second protective coating applied on the RFID tag antenna, the RFID IC, and the surface of the substrate. The layer of the first protective coating may have a shape and size that is substantially similar to a shape and size of the RFID tag antenna. The first protective coating may be an ultra-violet (UV) varnish. The RFID IC may be electrically coupled to the RFID tag antenna through galvanic coupling, capacitive coupling, or inductive coupling. The substrate may include one or more of satin, nylon, polyester, cotton, silk, recycled polyester, or Polyethylene Terephthalate (PET). The second protective coating may be varnish or flame-retardant material. The carelabel may be integrated into a garment and the substrate may be part of a garment fabric.

According to further examples, a method to manufacture a garment carelabel integrated with a radio frequency identification (RFID) tag is described. The method may include providing a flexible substrate, wherein the substrate is attached to a garment or integrated into a garment fabric; applying a layer of first protective coating on a surface of the substrate; printing an RFID tag antenna using conductive ink onto a portion of the surface of the substrate covered with the layer of the first protective coating, where the layer of the first protective coating prevents penetration of the substrate by the conductive ink; and electrically coupling an RFID integrated circuit (IC) to the RFID tag antenna.

According some examples, the method may further include applying a layer of second protective coating on the RFID tag antenna, the RFID IC, and the surface of the substrate. Applying the layer of the first protective coating on the surface of the substrate may include applying the layer of the first protective coating with a shape and size that is substantially similar to a shape and size of the RFID tag antenna. The method may also include partially or completely programming the RFID IC before electrically coupling the RFID IC to the RFID tag antenna. Electrically coupling the RFID IC to the RFID tag antenna may include electrically coupling the RFID IC to the RFID tag antenna through galvanic coupling, capacitive coupling, or inductive coupling.

According to other examples, a system to manufacture a garment carelabel integrated with a radio frequency identification (RFID) tag is described. The system may include a roller configured to provide a plurality of flexible substrates to be used as an attachable label or as part of a garment fabric; a first protective layer application module configured to deposit a layer of first protective coating on a surface of each of the plurality of substrates; a printer module configured to print an RFID tag antenna using conductive ink onto a portion of the surface of each of the plurality of substrates covered with the layer of the first protective coating, where the layer of the first protective coating prevents penetration of the substrate by the conductive ink; and an RFID integrated circuit (IC) application module configured to electrically couple an RFID IC to the RFID tag antenna on each of the plurality of substrates.

According to further examples, the system may also include a dryer module to dry the layer of the first protective coating prior to the printing of the RFID antenna. The system may further include a second protective layer application module configured to deposit a layer of second protective coating comprising protective varnish or flame-retardant material on the RFID tag antenna, the RFID IC, and the surface of each of the plurality of substrates. The system may also include a cutter module configured to separate columns of the plurality of substrates to be rolled into thermal printing ready rolls. The system may further include an RFID programming module configured to partially or completely program each RFID IC after electrically coupling each RFID IC to a corresponding RFID tag antenna. The system may also include a quality control module configured to perform one or more of a structural and a functional and RF performance quality check on each carelabel prior to cutting. The plurality of substrates may include one or more of satin, nylon, polyester, cotton, silk, recycled polyester, or Polyethylene Terephthalate (PET).

There are various vehicles by which processes and/or systems and/or other technologies described herein may be affected (e.g., hardware, software, and/or firmware), and the preferred vehicle will vary with the context in which the processes and/or systems and/or other technologies are deployed. For example, if an implementer determines that speed and accuracy are paramount, the implementer may opt for mainly hardware and/or firmware vehicle; if flexibility is paramount, the implementer may opt for mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing on one or more microprocessors), as firmware, or as virtually any combination thereof, and that designing the circuitry and/or writing the code for the software and/or firmware are possible in light of this disclosure.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only and is not intended to be limiting.

In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive (HDD), a compact disc (CD), a digital versatile disk (DVD), a digital tape, a computer memory, a solid state drive (SSD), etc.; and a transmission type medium such as a digital and/or an analog communication medium (e.g., a fiber optic cable, a waveguide, a wired communication link, a wireless communication link, etc.).

It is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. A data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors.

A data processing system may be implemented utilizing any suitable commercially available components, such as those found in data computing/communication and/or network computing/communication systems. The herein described subject matter sometimes illustrates different components contained within, or connected with, different other components. Such depicted architectures are merely exemplary, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1. A garment carelabel integrated with a radio frequency identification (RFID) tag, the carelabel comprising:
a flexible substrate;
a layer of first protective coating applied on a surface of the substrate;
an RFID tag antenna printed with conductive ink onto a portion of the surface of the substrate covered with the layer of the first protective coating, wherein the first protective coating prevents the conductive ink from penetrating the substrate; and
an RFID integrated circuit (IC) electrically coupled to the RFID tag antenna.

2. The garment carelabel of claim 1, further comprising:
a layer of second protective coating applied on the RFID tag antenna, the RFID IC, and the surface of the substrate.

3. The garment carelabel of claim 1, wherein the layer of the first protective coating has a shape and size that is substantially similar to a shape and size of the RFID tag antenna.

4. The garment carelabel of claim 1, wherein the first protective coating is an ultra-violet (UV) varnish.

5. The garment carelabel of claim 1, wherein the RFID IC is electrically coupled to the RFID tag antenna through galvanic coupling, capacitive coupling, or inductive coupling.

6. The garment carelabel of claim 1, wherein the substrate comprises one or more of satin, nylon, polyester, cotton, silk, recycled polyester, or Polyethylene Terephthalate (PET).

7. The garment carelabel of claim 22, wherein the second protective coating is varnish or flame-retardant material.

8. The garment carelabel of claim 1, wherein the carelabel is integrated into a garment and the substrate is part of a garment fabric.

9. A method to manufacture a garment carelabel integrated with a radio frequency identification (RFID) tag, the method comprising:
providing a flexible substrate, wherein the substrate is attached to a garment or integrated into a garment fabric;
applying a layer of first protective coating on a surface of the substrate;
printing an RFID tag antenna using conductive ink onto a portion of the surface of the substrate covered with the layer of the first protective coating, wherein the layer of the first protective coating prevents penetration of the substrate by the conductive ink; and
electrically coupling an RFID integrated circuit (IC) to the RFID tag antenna.

10. The method of claim 9, further comprising:
applying a layer of second protective coating on the RFID tag antenna, the RFID IC, and the surface of the substrate.

11. The method of claim 9, wherein applying the layer of the first protective coating on the surface of the substrate comprises:
applying the layer of the first protective coating with a shape and size that is substantially similar to a shape and size of the RFID tag antenna.

12. The method of claim 9, further comprising:
partially or completely programming the RFID IC before electrically coupling the RFID IC to the RFID tag antenna.

13. The method of claim 9, wherein electrically coupling the RFID IC to the RFID tag antenna comprises:
electrically coupling the RFID IC to the RFID tag antenna through galvanic coupling, capacitive coupling, or inductive coupling.

14.-20. (canceled)

21. A garment carelabel integrated with a radio frequency identification (RFID) tag, the carelabel comprising:
a flexible substrate;
a layer of varnish applied on a surface of the substrate as a first protective coating;
an RFID tag antenna printed with conductive ink onto a portion of the surface of the substrate covered with the layer of the varnish, wherein the layer of varnish prevents the conductive ink from penetrating the substrate; and
an RFID integrated circuit (IC) electrically coupled to the RFID tag antenna.

22. The garment carelabel of claim 21, further comprising:
a layer of second protective coating applied on the RFID tag antenna, the RFID IC, and the surface of the substrate.

23. The garment carelabel of claim 21, wherein the layer of varnish has a shape and size that is substantially similar to a shape and size of the RFID tag antenna.

24. The garment carelabel of claim 21, wherein the substrate comprises one or more of satin, nylon, polyester, cotton, silk, recycled polyester, or Polyethylene Terephthalate (PET).

25. The garment carelabel of claim 21, wherein the carelabel is integrated into a garment and the substrate is part of a garment fabric.
